(19) United States
(12) Patent Application Publication
(10) Pub. No.: US 2023/0315873 A1
(43) Pub. Date: Oct. 5, 2023

(54) INFORMATION PROCESSING APPARATUS AND CONTROL METHOD

(71) Applicant: SHARP KABUSHIKI KAISHA, Sakai City (JP)

(72) Inventors: HIROTOSHI OHKUBO, Sakai City (JP); HARUNOBU MORI, Sakai City (JP)

(73) Assignee: SHARP KABUSHIKI KAISHA, Sakai City (JP)

(21) Appl. No.: 18/126,748

(22) Filed: Mar. 27, 2023

(30) Foreign Application Priority Data
Mar. 30, 2022 (JP) 2022-056218

(51) Int. Cl. G06F 21/60; G06F 21/31; H04N 1/44

(52) U.S. Cl. CPC G06F 21/604; G06F 21/31; H04N 1/4406

(57) ABSTRACT

An information processing apparatus includes: an authenticator that authenticates a user according to a setting value; an acquirer that acquires the setting value; a determiner that determines whether a setting value of an administrator satisfies a rule with respect to authentication information included in the setting value acquired by the acquirer; and a processor that imports the setting value of a user other than the administrator as it is, when importing the setting value acquired by the acquirer, and performs processing of suspending importing, in a case where the determiner determines that the setting value of the administrator does not satisfy the rule.

### BACKGROUND OF THE INVENTION

### Field of the Invention

The present disclosure relates to an information processing apparatus, and the like.

### Description of the Background Art

Conventionally, information processing apparatuses such as multifunction devices have been widely used. In a case where a plurality of multifunction devices are installed, or in a case where multifunction devices are replaced, in order to facilitate settings of the multifunction devices, some multifunction devices have a function of importing pre-exported setting values (also, referred to as setting values of personal information of a user using a multifunction device, or user data). Some multifunction devices check setting values when importing the setting values, and import only setting values that conform to rules such as security rules, security policies, and password policies.

In a multifunction device in which security rules are operated, a technique of facilitating importing has also been proposed. For example, in a case where a setting value to be imported is associated with an individual personal setting for each user, a technique of performing import processing of a setting value regardless of a security rule has been proposed.

In the above-mentioned technique, regarding personal settings of a user, import of a setting value is executable regardless of a security rule. However, an idea as to whether the setting value is a setting value of an administrator or of a user having administrative authority is not taken into consideration. When a setting value of an administrator who does not satisfy a security rule, or a user having administrative authority is imported, the administrator or the user having administrative authority may not be able to log in to the multifunction device, and management of the multifunction device may not be performed. In a case where setting values of all administrators and all users having administrative authority are imported in an inappropriate state that does not satisfy security rules, there is a risk that none of the users who can manage the multifunction device is able to log in.

In view of the above-described problem, an object of the present disclosure is to provide an information processing apparatus and the like that can appropriately introduce user setting values.

### SUMMARY OF THE INVENTION

In order to solve the above-described problem, an information processing apparatus according to the present disclosure includes: an authenticator that authenticates a user according to a setting value; an acquirer that acquires the setting value; a determiner that determines whether a setting value of an administrator satisfies a rule with respect to a setting value included in the setting value acquired by the acquirer; and a processor that imports the setting value of a user other than the administrator as it is, when importing the setting value acquired by the acquirer, and performs processing of suspending importing, in a case where the determiner determines that the setting value of the administrator does not satisfy the rule.

Further, a control method according to the present disclosure includes: acquiring a setting value; determining whether a setting value of an administrator, among the setting value, satisfies a setting value rule; and importing the setting value of a user other than the administrator as it is, when importing the setting value, and performing processing of suspending importing, in a case where the setting value of the administrator does not satisfy the rule.

According to the present disclosure, it is possible to provide an information processing apparatus and the like that can appropriately introduce user setting values.

### BRIEF DESCRIPTION OF THE DRAWINGS

FIG. 1 is an external perspective view of a multifunction device according to a first embodiment.

FIG. 2 is a diagram illustrating a functional configuration of the multifunction device according to the first embodiment.

FIG. 3 is a diagram illustrating a data structure of identification authentication information according to the first embodiment.

FIG. 4 is a diagram illustrating a data structure of unavailable login name information according to the first embodiment.

FIG. 5 is a diagram illustrating a data structure of a system setting information table according to the first embodiment.

FIG. 6 is a flowchart illustrating a flow of import processing according to the first embodiment.

FIG. 7 is a flowchart illustrating a flow of administrator password change processing according to the first embodiment.

FIG. 8 is a flowchart illustrating a flow of login processing according to the first embodiment.

FIG. 9 is a flowchart illustrating a flow of password change processing according to the first embodiment.

FIGS. 10A to 10C are diagrams illustrating an operation example according to the first embodiment.

FIGS. 11A to 11C are diagrams illustrating an operation example according to the first embodiment.

FIGS. 12A to 12C are diagrams illustrating an operation example according to the first embodiment.

FIG. 13 is a flowchart illustrating a flow of password change processing according to a second embodiment.

FIGS. 14A to 14C are diagrams illustrating an operation example according to the second embodiment.

FIG. 15 is a diagram illustrating an overall configuration of a system according to a third embodiment.

FIG. 16 is a flowchart illustrating a flow of password change processing according to the third embodiment.

FIG. 17 is a flowchart illustrating a flow of password-associated change processing according to the third embodiment.

### DESCRIPTION OF THE PREFERRED EMBODIMENTS

Hereinafter, embodiments for implementing the present disclosure are described with reference to the drawings. Note that, the following embodiments are an example for describing the present disclosure, and the technical scope of the disclosure described in the claims is not limited to the following description.

### 1. First Embodiment

A first embodiment is described regarding a case in which an information processing apparatus according to the present disclosure is applied to a multifunction device 10. The multifunction device 10 is an information processing apparatus having a copy function, a scanner function, a printer function, and other functions, and is also called a multi-function printer/peripheral (MFP) or an image forming apparatus.

### 1.1 Functional Configuration

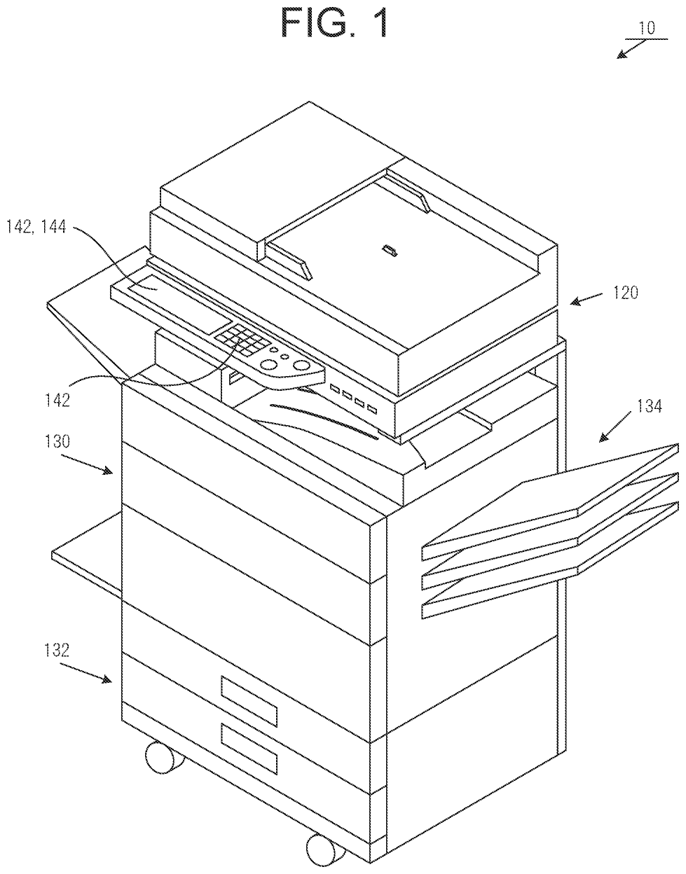

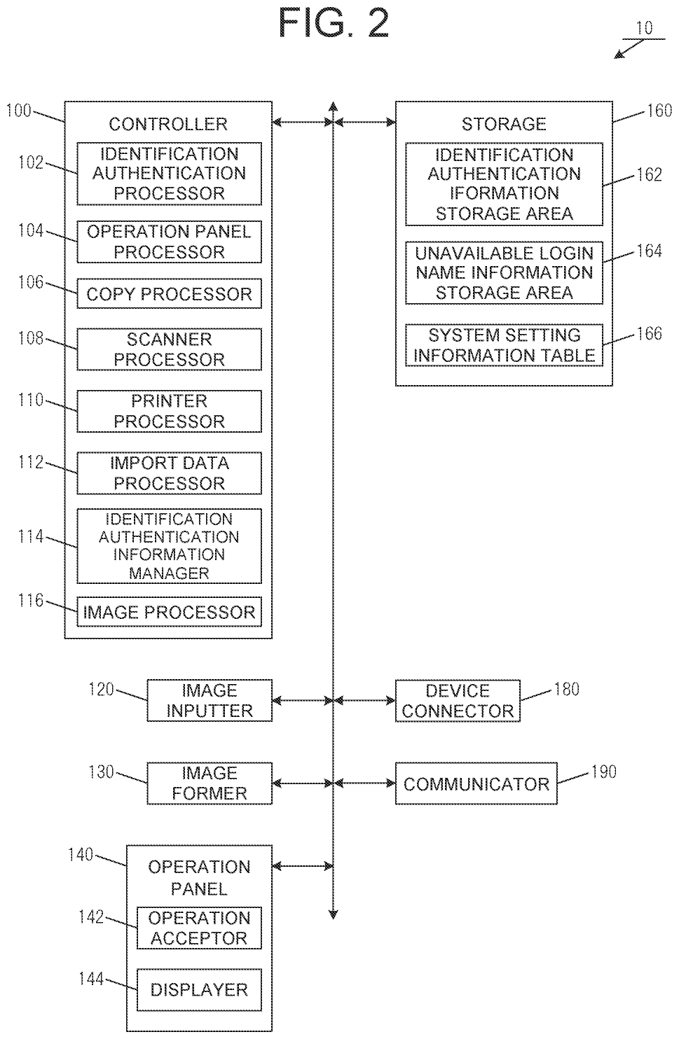

A functional configuration of the multifunction device 10 according to the present embodiment is described. FIG. 1 is an external perspective view of the multifunction device 10, and FIG. 2 is a block diagram illustrating the functional configuration of the multifunction device 10.

As illustrated in FIG. 2, the multifunction device 10 includes a controller 100, an image inputter 120, an image former 130, an operation panel 140, a storage 160, a device connector 180, and a communicator 190.

The controller 100 is a functional unit for controlling the entirety of the multifunction device 10. The controller 100 achieves various functions by reading and executing various programs stored in the storage 160. For example, the controller 100 is constituted of one or more arithmetic devices (central processing units (CPUs)) and the like. The controller 100 may also be configured as a system on a chip (SoC) having a plurality of functions among the functions described below.

The controller 100 also functions as an identification authentication processor 102, an operation panel processor 104, a copy processor 106, a scanner processor 108, a printer processor 110, an import data processor 112, an identification authentication information manager 114, and an image processor 116 by executing the programs stored in the storage 160.

The identification authentication processor 102 performs identification and authentication of a user who uses the multifunction device 10. For example, the identification authentication processor 102 performs multifunction device authentication (internal authentication). The internal authentication is a method in which identification authentication information being information for use in identification and authentication of a user is stored in advance, and in a case where identification authentication information that matches information input by the user when using the multifunction device 10 is stored, the user associated with the identification authentication information is authenticated. Note that, the identification authentication processor 102 may also transmit identification authentication information to a server device having an authentication function of performing authentication of a user, and authenticate the user according to a result of authentication by the server device (external authentication).

The operation panel processor 104 controls display of the operation panel 140, and acquires a content input by the user via the operation panel 140.

The copy processor 106 achieves a copy function. For example, the copy processor 106 inputs an image by controlling the image inputter 120, and forms (prints) the image on a recording medium such as recording paper by controlling the image former 130.

The scanner processor 108 achieves a scanner function. For example, the scanner processor 108 inputs an image by controlling the image inputter 120, stores the image in the storage 160, stores the image in a device (recording medium) connected to the device connector 180, or transmits the image to another device via the communicator 190.

The printer processor 110 achieves a printer function. For example, the printer processor 110 receives print data (e.g., page description language (PDL) data) from an external device via the communicator 190, and forms (prints) an image based on the print data, on a recording medium such as recording paper by controlling the image former 130.

The import data processor 112 acquires import data from another device via the device connector 180 or the like, and performs import processing of storing the import data in the storage 160. The import data are, for example, a setting value (user data) of personal information of a user of another multifunction device 10, which has been exported from the another multifunction device 10, and are data to be imported to the multifunction device 10. The import data may include setting values (user data) of a plurality of users. The import processing is described later.

The identification authentication information manager 114 manages identification authentication information. For example, the identification authentication information manager 114 refers to a system setting information table 166 to be described later, and in a case where there is a user who has not logged in for a predetermined period of time, the identification authentication information manager 114 deletes identification authentication information of the user. In addition, the identification authentication information manager 114 makes information included in the deleted identification authentication information unavailable. For example, in a case where identification authentication information includes a login name for use in identifying the user, the identification authentication information manager 114 stores, in an unavailable login name information storage area 164, unavailable login name information including the login name. Note that, the identification authentication information manager 114 may make information that has been made unavailable available again after a predetermined period of time has elapsed since the information was made unavailable. For example, the identification authentication information manager 114 stores information on a date (start date) when information was made unavailable, as unavailable login name information, along with a login name that was made unavailable. Also, the identification authentication information manager 114 deletes, from the unavailable login name information storage area 164, the unavailable login name information after a predetermined period of time has elapsed from the start date. This allows the unavailable login name to be used again. Note that, settings as to determination whether to delete identification authentication information, an unlogged period of time during which identification authentication information is determined to be deleted, settings whether to prohibit reuse of a login name included in the deleted identification authentication information, and settings on a period of time during which reuse is permitted are stored, for example, in the system setting information table 166 to be described later. In this case, the identification authentication information manager 114 deletes identification authentication information, and stores or deletes unavailable login name information by referring to the system setting information table 166.

The image processor 116 performs processing related to various images. For example, the image processor 116 performs sharpening processing and gradation conversion processing with respect to an image input by the image inputter 120.

The image inputter 120 reads an image on a document, and inputs the image to the multifunction device 10. For example, the image inputter 120 is constituted of a scanner device or the like that reads a document placed on a document table. The scanner device is a device that converts an image into an electrical signal by an image sensor such as a charge coupled device (CCD) or a contact image sensor (CIS), and quantizes and encodes the electrical signal.

The image former 130 forms (prints) an image on a recording medium such as recording paper. The image former 130 is constituted, for example, of a printing device such as a laser printer utilizing an electrophotographic method. The image former 130, for example, feeds recording paper from a paper feed tray 132 illustrated in FIG. 1, forms an image on a surface of the recording paper, and discharges the recording paper from a paper discharge tray 134.

The operation panel 140 inputs an operation with respect to the multifunction device 10, and displays various pieces of information. The operation panel 140 is configured to include an operation acceptor 142 and a displayer 144. The operation acceptor 142 is constituted of an input device such as setting buttons and numeric keys for inputting an operation mode and various settings of the multifunction device 10. The displayer 144 is constituted of a display device such as a liquid crystal display (LCD), an electro-luminescence (EL) display, and a micro-LED display. The operation panel 140 may be a touch panel integrally constituted of the operation acceptor 142 and the displayer 144. In this case, a method of detecting an input on a touch panel may be any general detection method such as, for example, a resistive film method, an infrared method, an electromagnetic induction method, or a capacitance method.

Note that, the multifunction device 10 may include an interface (operation I/F) connectable to an input device such as a keyboard, or a display device such as a display together with the operation panel 140. In this case, the multifunction device 10 may acquire information input via the input device, or display information via the display device.

The storage 160 stores various programs necessary for an operation of the multifunction device 10, and various pieces of data. The storage 160 is constituted of a storage device such as, for example, a solid state drive (SSD) being a semiconductor memory, or a hard disk drive (HDD).

The storage 160 secures, as a storage area, an identification authentication information storage area 162 and the unavailable login name information storage area 164, and also stores the system setting information table 166.

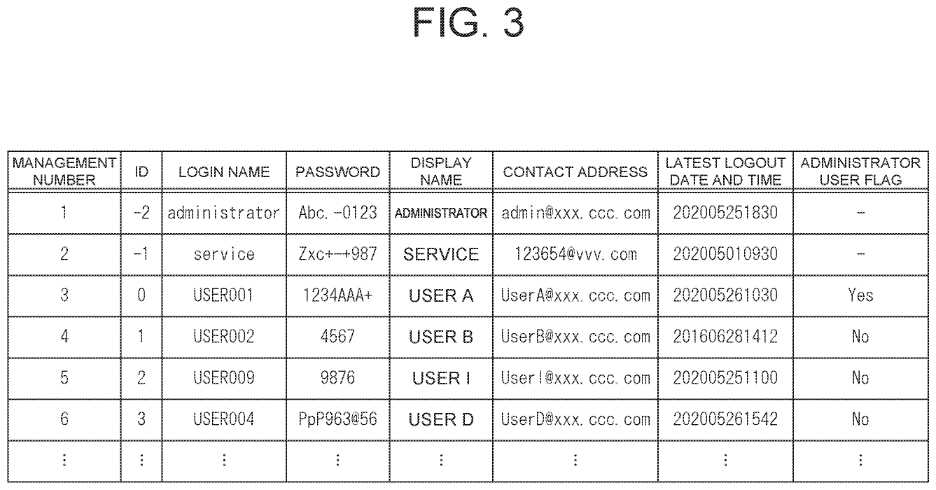

The identification authentication information storage area 162 stores identification authentication information. As illustrated in FIG. 3, for example, the identification authentication information includes a management number (e.g., “3”) of the identification authentication information, an ID (e.g., “0”) for identifying the identification authentication information, a login name (e.g., “USER001”), a password (e.g., “1234AAA+”), a display name (e.g., “user A”), a contact address (e.g., “UserA@xxx.ccc.com”), a latest logout date and time (e.g., “202005261030”), and an administrator user flag (e.g., “Yes”).

As illustrated in FIG. 3, the identification authentication information includes information (e.g., a login name) for use in identification of a user, and information (e.g., a password) for use in authentication of a user. Furthermore, the identification authentication information includes user-specific information such as a display name and a contact address. As described above, the identification authentication information is a personal setting of a user of the multifunction device 10, and is also referred to as account information or authentication data.

Note that, the administrator user flag included in the identification authentication information is information indicating whether the user is a user having equal authority to the administrator to be described later, and when the user is a user having administrative authority, “Yes” is stored, and when the user is a user who does not have administrative authority, “No” is stored.

In the present embodiment, it is assumed that there are administrators and general users, as users of the multifunction device 10. An administrator is a user who has authority for managing the multifunction device 10, and is a device administrator or a service person. Note that, the device administrator is a special user designated by the manufacturer of the multifunction device 10. In the present embodiment, it is assumed that the ID of a device administrator is “−2”, and the ID of a service person is “−1”.

The general user is a user other than administrators. In the present embodiment, it is assumed that the ID of a general user is an integer equal to or more than 0. Note that, as described above, general users may include a user who has equal authority to the administrator. A user having equal authority to the administrator is also referred to as an administrator user.

Identification authentication information of the administrator is stored in advance in the identification authentication information storage area 162. The administrator also registers a general user by performing an operation of adding a user with respect to the multifunction device 10. Thus, identification authentication information of a general user is stored in the identification authentication information storage area 162.

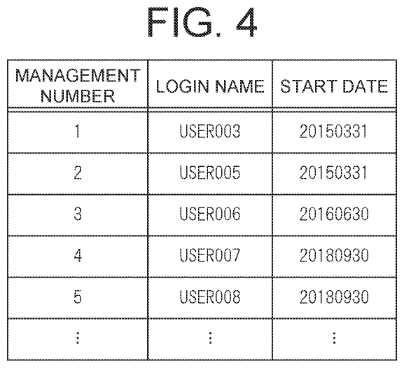

The unavailable login name information storage area 164 stores unavailable login name information, which is information related to an unavailable login name. The unavailable login name information includes, as illustrated in FIG. 4, for example, a management number (e.g., “1”) of unavailable login name information, an unavailable login name (e.g., “USER003”), and a start date (e.g., “20150331”) of an unavailable period.

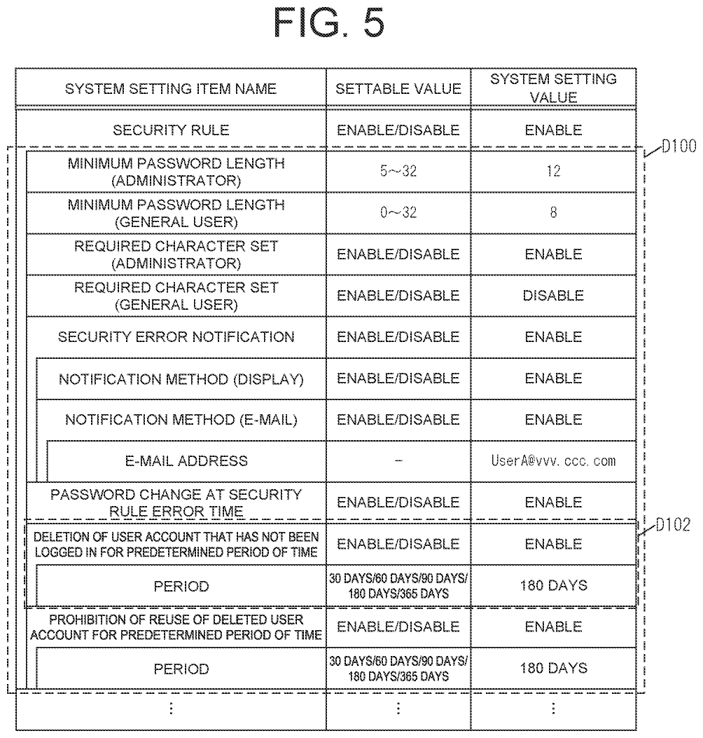

The system setting information table 166 is a table that stores information related to settings (system settings) of the multifunction device 10. For example, as illustrated in FIG. 5, a table in which a system setting item name indicating an item name of a system setting, a settable value indicating a range or a type settable as a setting value (system setting value) for the item, and a system setting value set for the item are associated with one another is stored as the system setting information table 166.

The system setting information table 166 includes settings related to security rules to be applied to the multifunction device 10. The security rules are rules (regulations) for operating the multifunction device 10 securely, and are settings for increasing security of the multifunction device 10, and improving convenience of the multifunction device 10. The multifunction device 10 achieves predetermined functions in accordance with the security rules.

The multifunction device 10 achieves, for example, a function of strengthening a password at a login time, and a function of strengthening account management in order to enhance security.

By achieving the function of strengthening a password at a login time, the multifunction device 10 behaves, for example, as follows.
A minimum value is set for the length of a password, and use of a short password is restricted (refused).
A character set for use in a password is made complicated, and use of a password in which a required character set is not used is restricted (refused).
Change to a password that has been used in the past is restricted (refused), when changing the password.

In this way, settings related to the function of strengthening a password at a login time among the security rules are regulations related to a password included in identification authentication information. In other words, by enabling security rules related to a password, the security rules are applied to the password, the length of the password or the character set for use in the password is made complicated, and a security level is increased.

In addition, by achieving the function of strengthening account management, the multifunction device 10 behaves, for example, as follows.
An unused account is automatically deleted.
Reuse of the same account (re-registration under the same account name) for a predetermined period of time is restricted (refused).

Further, to improve convenience, the multifunction device 10 detects, for example, an error (login error) that has occurred at a login time, and notifies the administrator of the event that has occurred. This allows the administrator to recognize the event that has occurred in real time.

In order to perform the settings described above, in the present embodiment, settings on enable/disable are individually made possible for the following setting items, as settings for individual rules included in security rules.
Minimum password length
Complication of a character set for use in a password (settings on a required character set)
Restriction of reuse of a password
Automatic deletion of an unused account
Restriction of reuse of an account
Notification at an error time

For each of the settings described above, a parent setting capable of controlling enable/disable in a batch manner may be provided. For example, as illustrated in FIG. 5, in a case where enable/disable of “a security rule” is settable, and “the security rule” is “enabled”, a setting content (D100 in FIG. 5) related to the security rule is enabled. In this case, in a case where “the security rule” is “disabled,” the setting content (D100 in FIG. 5) related to the security rule is disabled. In other words, only in a case where a parent setting is enabled, each child setting functions according to a setting content of each child setting. Each child setting may be settable only in a case where a parent setting is enabled, or may be settable independently of a state as to whether a parent setting is enabled or disabled. Further, in a case where a parent setting is disabled, a child setting may be initialized, or a system setting value of a child setting may be retained.

Further, in some of the security rules, a system setting value may be available individually for an administrator and a general user, such as a setting item of a minimum password length, and a required character set in FIG. 5. Note that, the system setting value of an administrator user may depend on either a system setting value for an administrator, or a system setting value for a general user. In this case, a system setting value may depend, for “all administrator users”, either on a system setting value for an administrator or a system setting value for a general user; and it may be selectable in such a way that, for “each administrator user”, a system setting value depends either on a system setting value for an administrator or a system setting value for a general user, for each user.

Note that, as illustrated in D102 in FIG. 5, there may also be settings having a relationship between a parent setting and a child setting among child settings of security rules. In D102 in FIG. 5, “deletion of a user account that has not been logged in for a predetermined period of time” indicates a parent setting, and “a period” indicates a child setting.

The device connector 180 connects the multifunction device 10 to another device directly or via a cable. The device connector 180 is configured, for example, as an interface (device I/F) that can connect the multifunction device 10 to another device. The another device may be a storage device (storage medium) such as a universal serial bus (USB) memory, or an information processing terminal such as a personal computer (PC).

The communicator 190 connects another device to the multifunction device 10 via a network such as a local area network (LAN) or a wide area network (WAN). The communicator 190 may, for example, be constituted of a communication device such as a network interface card (NIC) for use in a wired/wireless LAN, or a communication module, and may include an interface (network I/F) connectable to a network. The communicator 190 may also be connected to a communication network such as a public line network, a LAN, or the Internet, and may be able to transmit data externally via the communication network by a communication method such as facsimile, or e-mail. Further, the another device may be a PC or a server device, or may be a portable information processing terminal such as a laptop computer, a tablet computer, or a smartphone.

### 1.2 Flow of Processing

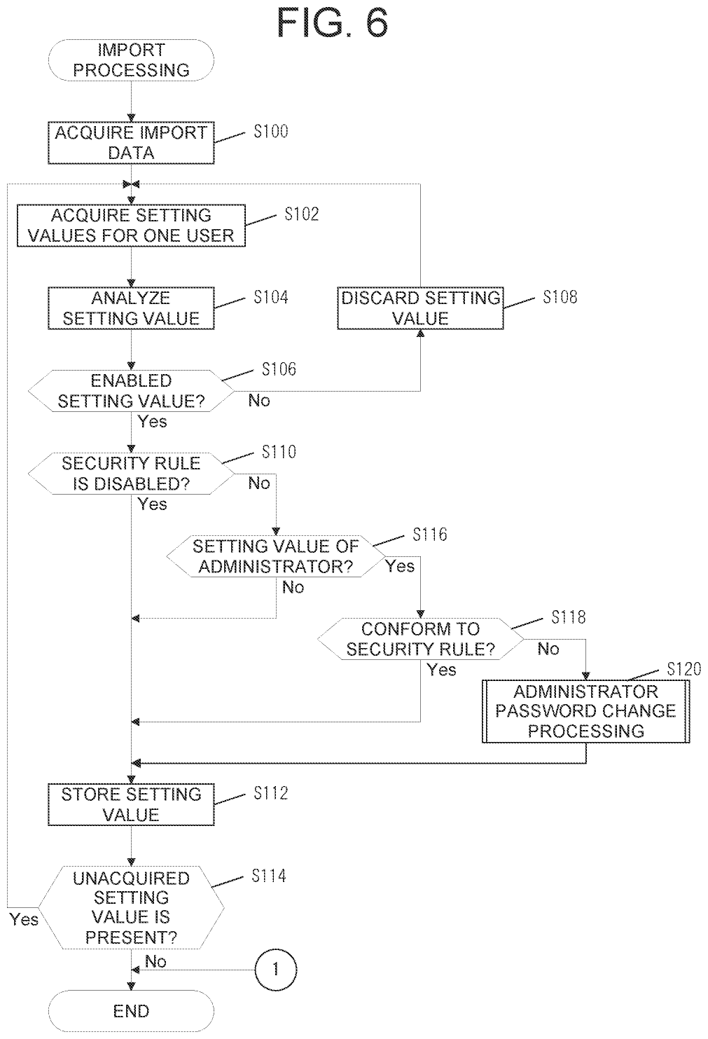

Processing to be performed by the multifunction device 10 is described with reference to FIGS. 6 through 9. Pieces of processing described in FIGS. 6 through 9 are performed by causing the controller 100 to read a program stored in the storage 160.

1.2.1 Import Processing

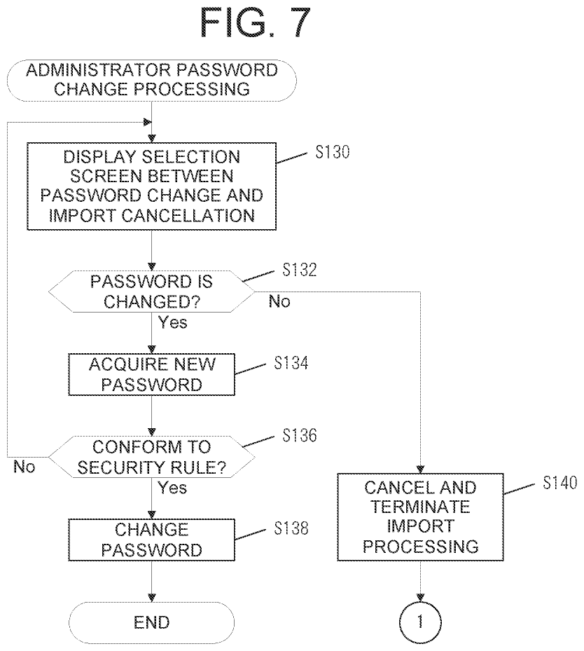

FIGS. 6 and 7 are flowcharts illustrating a flow of import processing. The import processing is performed by the import data processor 112 of the controller 100, in a case where an import operation of import data is performed by the administrator.

In the following description, a case in which the controller 100 stores (imports) a setting value included in import data, as identification authentication information is described. In other words, it is assumed that setting values included in import data include at least information associated with an ID, a login name, and a password. Further, it is also assumed that the system setting information table 166 stores setting information on security rules for a password.

First, the import data processor 112 acquires import data (step S100). For example, the import data processor 112 reads import data stored in a USB memory or the like via the device connector 180, or receives import data from another device via the communicator 190.

Subsequently, the import data processor 112 acquires setting values for one user from the import data acquired in step S100 (step S102). Note that, the setting values for one user acquired in step S102 are also referred to as target setting values.

Subsequently, the import data processor 112 analyzes the target setting value (step S104). For example, the import data processor 112 analyzes whether the target setting value can be stored as identification authentication information. Note that, the import data processor 112 may analyze whether a login name included in the target setting value is included as a login name of unavailable login name information, or may perform any other necessary analysis.

Subsequently, the import data processor 112 determines whether the target setting value is a valid setting value (valid data set), as a result of the analysis in step S104 (step S106). For example, the import data processor 112 determines that the target setting value is not a valid setting value, in a case where information necessary to be stored as identification authentication information is not included in the target setting value, or in a case where a login name included in the target setting value is included in the login name of any piece of the unavailable login name information.

In a case where the target setting value is not a valid setting value (data set) in step S106, the import data processor 112 discards the target setting value, and returns to step S102 (step S106; No→step S108→step S102).

On the other hand, in a case where the import data processor 112 determines that the target setting value is a valid setting value in step S106, the import data processor 112 determines whether the security rule is enabled, based on the system setting information table 166 (step S106; Yes→step S110).

In a case where the security rule is disabled, the import data processor 112 stores the target setting value in the identification authentication information storage area 162, as identification authentication information (step S110; Yes→step S112).

Subsequently, the import data processor 112 determines whether there is an unacquired setting value among the import data acquired in step S100 (step S114). In a case where there is an unacquired setting value, the import data processor 112 returns to step S102 (step S114; Yes→step S102). On the other hand, in a case where the import data processor 112 has acquired all setting values, the import data processor 112 terminates the processing illustrated in FIG. 6 (step S114; No).

Further, in a case where the import data processor 112 determines that the security rule is enabled in step S110, the import data processor 112 determines whether the target setting value is a setting value of the administrator (step S110; No→step S116). For example, when the import data processor 112 stores the target setting value, as identification authentication information, the import data processor 112 determines whether the target setting value is a setting value of the administrator, based on whether the ID included in the identification authentication information is “−2” or “−1”.

In a case where the target setting value is not a setting value of the administrator, the import data processor 112 stores the target setting value (step S116; No→step S112). On the other hand, in a case where the import data processor 112 determines that the target setting value is a setting value of the administrator in step S116, the import data processor 112 determines whether the target setting value conforms to the security rule (satisfies the security rule) (step S116; Yes→step S118).

In a case where the target setting value conforms to the security rule (satisfies the security rule), the import data processor 112 stores the target setting value (step S118; Yes→step S112). On the other hand, in a case where the target setting value does not conform to the security rule (does not satisfy the security rule), the import data processor 112 suspends the import processing, and changes the target setting value in such a way as to conform to the security rule. In the present embodiment, in order to change the password included in the target setting value in such a way as to conform to the security rule (password policy) for the password, the import data processor 112 performs administrator password change processing (step S118; No→step S120).

The administrator password change processing is described with reference to FIG. 7. The import data processor 112 displays, on the displayer 144, a selection screen capable of selecting either password change or import cancellation (step S130).

Subsequently, the import data processor 112 acquires a new password, in a case where password change is selected based on a user operation (step S132; Yes→step S134). For example, the import data processor 112 displays a password input screen on the displayer 144, and acquires a character string input via the input screen, as a new password.

Subsequently, the import data processor 112 determines whether the password acquired in step S134 conforms to the security rule (step S136). In a case where the password acquired in step S134 conforms to the security rule, the import data processor 112 changes the password (step S136; Yes→step S138). Specifically, the import data processor 112 changes the setting value of the administrator to a new setting value.

Note that, after performing the processing in step S138, the import data processor 112 performs step S112 in FIG. 6. This allows the import data processor 112 to store the target setting value including the password changed in step S138, as identification authentication information.

Note that, in a case where the import data processor 112 determines that import cancellation is selected in step S132, the import data processor 112 cancels and terminates the import processing (step S32; No→step S140). At this occasion, the import data processor 112 may recover the identification authentication information stored in the identification authentication information storage area 162 to a state before import processing. Also, after performing the processing in step S140, the import data processor 112 returns to FIG. 6, and terminates the processing illustrated in FIG. 6 as it is. Thus, the import data processor 112 cancels and terminates the import processing without importing import data.

In this way, by performing the processing illustrated in FIG. 7, the import data processor 112 allows the administrator to change the password on the spot, in a case where the setting value of the administrator does not conform to the security rule related to the password.

Note that, the import data processor 112 may allow the user (administrator) to input a password twice in step S134 in FIG. 7. In this case, when the input password is the same for both times, the controller 100 performs determination (processing in step S136) as to whether the input password conforms to the security rule. On the other hand, in a case where the input password is different between the first time and the second time, the import data processor 112 starts over from password input for the first time.

Note that, the import processing described above is processing in a case where changing a password is made possible, in a case where a setting value of the administrator does not conform to a security rule related to the password. Herein, in place of the processing described above, in a case where a setting value of the administrator does not conform to a security rule related to a password, the import data processor 112 may terminate the import processing as an error, assuming that an import error has occurred. In this case, when the import data processor 112 acquires a setting value that does not conform to a security rule related to a password, the import data processor 112 does not allow the administrator to change the password, recovers the identification authentication information stored in the identification authentication information storage area 162 to a state before import processing, and terminates the import processing.

In the import processing described above, the controller 100 (import data processor 112) may also check whether a setting value of an administrator user also conforms to the security rule. In this case, the controller 100 (import data processor 112) determines whether the target setting value is a setting value of the administrator or a setting value of the administrator user in step S116 in FIG. 6. In a case where the target setting value is a setting value of the administrator or a setting value of the administrator user, the import data processor 112 further determines whether the target setting value conforms to the security rule by performing the processing in step S118 in FIG. 6. In a case where the target setting value is a setting value of the administrator, and the setting value does not conform to the security rule (in case of an error), the import data processor 112 may make the setting value of the administrator user changeable as is. In addition, even in a case where the import data processor 112 makes the setting value of the administrator changeable, the import data processor 112 may allow the user to optionally select whether to change the setting value of the administrator user. In this case, the import data processor 112 may skip import of the setting value of the administrator user, when the setting value of the administrator user is not changed. Thus, the import data processor 112 can skip importing a setting value of the administrator user that does not conform to the security rule.

Furthermore, the import data processor 112 may set in advance a priority for an administrator user, based on import data, and the like, and determine whether a setting value of the administrator user conforms to the security rule, only for a setting value of the administrator user having a high priority. In this case, in a case where the setting value of the administrator user having a high priority does not conform to the security rule, the import data processor 112 may make the setting value changeable, or may skip importing the setting value. Note that, a setting value of an administrator user having a low priority is imported as it is, without determination as to whether the setting value conforms to the security rule. Thus, the import data processor 112 can import the setting value of the administrator user having a high priority after making the setting value conform to the security rule.

Although it is supposed that import processing is performed by an administrator, the import processing may be performed by an administrator user. In this case, a user who is allowed to change the password at the time of import may be set among the administrator users, as well as the administrator. Note that, in a case where there are a plurality of administrator users, there may be a user who is not allowed to change the password at the time of import, even when the user is an administrator user. In this case, setting information indicating whether the user is an administrator user who is not allowed to change the password may be provided in setting values (account settings).

1.2.2 Login Processing

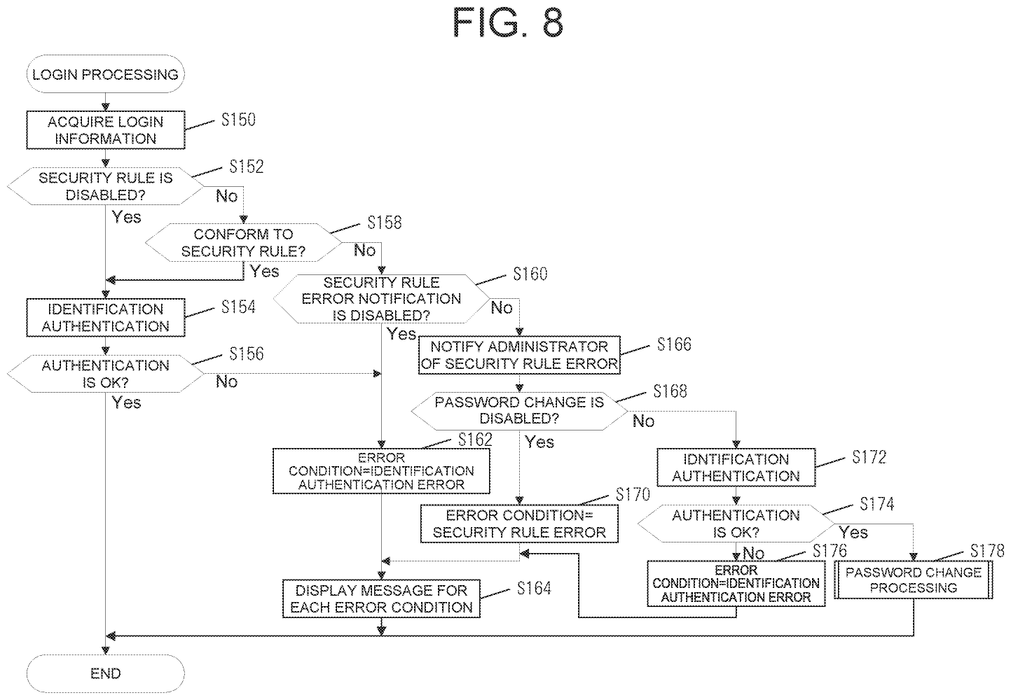

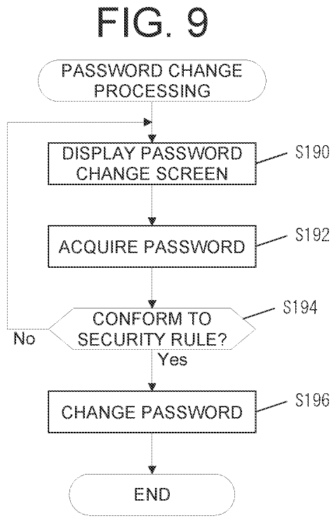

FIGS. 8 and 9 are flowcharts illustrating a flow of login processing. The login processing is processing to be performed when a user performs a login operation to the multifunction device 10. Note that, the user may perform a login operation by operating the multifunction device 10, or may perform a login operation via a device owned by the user and connected to the multifunction device 10.

First, the controller 100 acquires login information (step S150). The login information is information necessary for login to the multifunction device 10, and, for example, is a login name and a password. The controller 100 acquires login information input via a login screen by displaying, on the displayer 144, a screen (login screen) for allowing the user to input a login name and a password, or by displaying a login screen on a device to be used by the user.

Subsequently, the controller 100 determines whether the security rule is enabled (step S152).

In a case where the security rule is disabled, the controller (identification authentication processor 102) identifies and authenticates the user, based on the login information acquired in step S150 (step S152; Yes→step S154). The controller 100 (identification authentication processor 102) determines whether authentication is successful (step S156). In a case where authentication is successful, the controller 100 terminates the processing illustrated in FIG. 8 (step S156; Yes). In this case, the controller 100 performs post-login processing. The post-login processing means, for example, displaying, on the displayer 144 or a device to be used by the user, a home screen that displays buttons for selecting a function of the multifunction device 10 and information on the multifunction device 10. In this way, in a case where the security rule is disabled, the user can log in to the multifunction device 10, and use the multifunction device 10, regardless of whether a user setting value conforms to the security rule.

On the other hand, in a case where the security rule is enabled, the controller 100 determines whether the login information acquired in step S150 conforms to the security rule (step S152; No→step S158).

The controller 100 performs the processing in step S154, in a case where the login information conforms to the security rule (step S158; Yes→step S154).

On the other hand, in a case where the login information does not conform to the security rule, the controller 100 determines whether a security rule error notification to the user is disabled regarding an error (security rule error) based on that the login information does not conform to the security rule (step S158; No→step S160). For example, the controller 100 determines that a security rule error notification to the user is enabled, in a case where a system setting value of the security rule error notification is “enabled”, and a system setting value for a notification by display (notification method (display)) is “enabled” by referring to the system setting information table 166. On the other hand, in a case where either the system setting value for the security rule error notification, or the system setting value for the notification by display is “disabled”, the controller 100 determines that the security rule error notification to the user is disabled.

In a case where the security rule error notification to the user is disabled, the controller 100 sets the error condition to “an identification authentication error” (step S160; Yes→step S162). The error condition is information indicating a content of an error that has occurred in the multifunction device 10. The controller 100 also displays a message for each error condition (step S164). For example, the controller 100 displays a message on the displayer 144, in a case where a login operation has been performed via the multifunction device 10. On the other hand, in a case where a login operation is performed via the user device, the controller 100 causes the device to display a message by transmitting, to the device, information for displaying the message on the device. In this way, the controller 100 displays a general error message such as a login error (an authentication error indicating that authentication has failed), even in a case where a setting value of the user who is trying to log in to the multifunction device 10 does not conform to the security rule. This allows the controller 100 to prevent the user from recognizing that the setting value does not conform to the security rule.

On the other hand, in a case where the security rule error notification is enabled in step S160, the controller 100 notifies the administrator of the security rule error (step S160; No→step S166). For example, the controller 100 transmits an e-mail including a content indicating that a security rule error has occurred by using, as a destination, an e-mail address stored as a contact address of the administrator, or an e-mail address stored as a transmission destination of a security error notification stored in the system setting information table 166. This allows the controller 100 to notify the administrator, in a case where an event that the user cannot log in has occurred, because a setting value of the user who tries to log in to the multifunction device 10 does not conform to the security rule. This allows the administrator to confirm occurrence of an event after the event has occurred, and recognize the time when the event has occurred. Also, the administrator can recognize that the password is about to be changed by a user who has set the password that does not conform to the security rule, independently of a notification to the user who logs in to the multifunction device 10. Note that, the controller 100 may store the event in the storage 160. The controller 100 may also omit the processing in step S166, in a case where a system setting value of a security error notification is “disabled”, or a system setting value of a security error notification by an e-mail is “disabled”.

Subsequently, the controller 100 determines whether password change at a time of occurrence of a security rule error is enabled (step S168). In a case where password change at a time of occurrence of a security rule error is disabled, the controller 100 sets the error condition to “a security rule error”, and displays a message for each error condition (step S168; Yes→step S170→step S164).

On the other hand, in a case where password change at a time of occurrence of a security rule error is enabled, the controller 100 (identification authentication processor 102) performs identification authentication (step S168; No→step S172).

The controller 100 determines whether the user has been authenticated (step S174). In a case where the user could not be authenticated, the controller 100 sets the error condition to “an identification authentication error”, and displays a message for each error condition (step S174; No→step S176→step S164).

On the other hand, in a case where authentication is successful, the controller 100 performs processing of changing the password (password change processing) (step S174; Yes→step S178).

The password change processing is described with reference to FIG. 9. Note that, in the following description, a case in which an operation for changing the password is performed via the multifunction device 10 is described, but the password may be edited (re-registered) in a device connected to the multifunction device.

First, the controller 100 displays a password change screen on the displayer 144 or on a device to be used by the user (step S190). Subsequently, the controller 100 acquires the password input by the user via the password change screen (step S192).

Subsequently, the controller 100 determines whether the password acquired in step S192 conforms to the security rule (step S194). In a case where the password acquired in step S192 conforms to the security rule, the controller 100 changes the password (step S194; Yes→step S196). For example, the controller 100 changes the password included in the identification authentication information of the user authenticated in step S172 in FIG. 8 to the password (new password) acquired in step S192. In other words, the controller 100 changes the user setting value to a new setting value. On the other hand, the controller 100 returns to step S190, in a case where the password does not conform to the security rule (step S194; No→step S190).

Note that, the controller 100 may allow the user to input the password twice in step S192. In this case, when the input password is the same for both times, the controller 100 determines whether the input password conforms to the security rule (processing in step S194). On the other hand, in a case where the input password is different between the first time and the second time, the controller 100 starts over from password input for the first time.

In this way, in a case where the security rule is enabled, as far as the user setting value conforms to the security rule, the user can log in to the multifunction device 10, and can use the multifunction device 10. On the other hand, in a case where the user setting value does not conform to the security rule, the user cannot log in to the multifunction device 10. Further, in a case where the user cannot log in, the controller 100 displays a message in step S164 in FIG. 8. At this occasion, in a case where the security rule error notification to the user is disabled, the controller 100 displays a general error message. This allows the controller 100 to make the user aware that the setting value does not conform to the security rule, as a login error, irrespective of an existing authentication error. Note that, in a case where the security rule error notification is enabled, the controller 100 can also make the user aware that the reason for not being able to log in is that the setting value does not conform to the security rule.

### 1.3 Operation Example

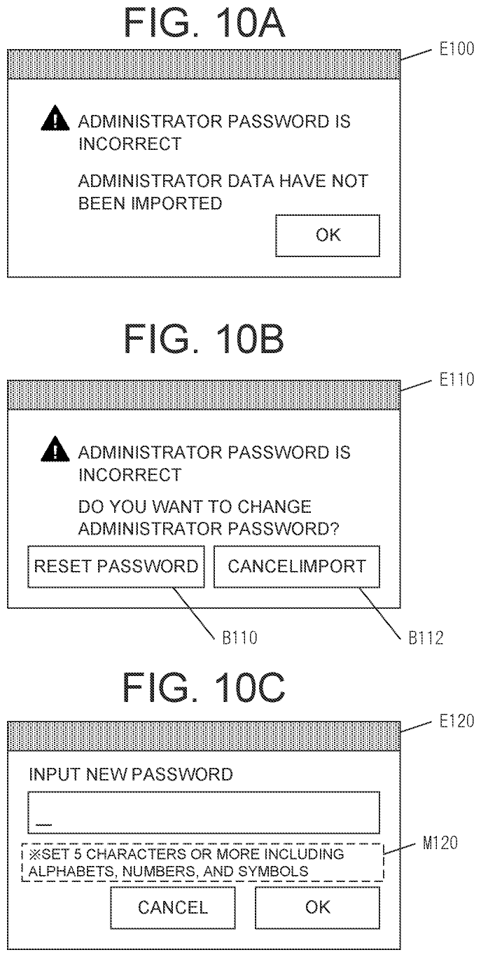

An operation example of the multifunction device 10 according to the present embodiment is described with reference to FIGS. 10A through 12C. The drawings illustrated in FIGS. 10A through 12C are diagrams illustrating screen examples to be displayed on the displayer 144 of the operation panel 140.

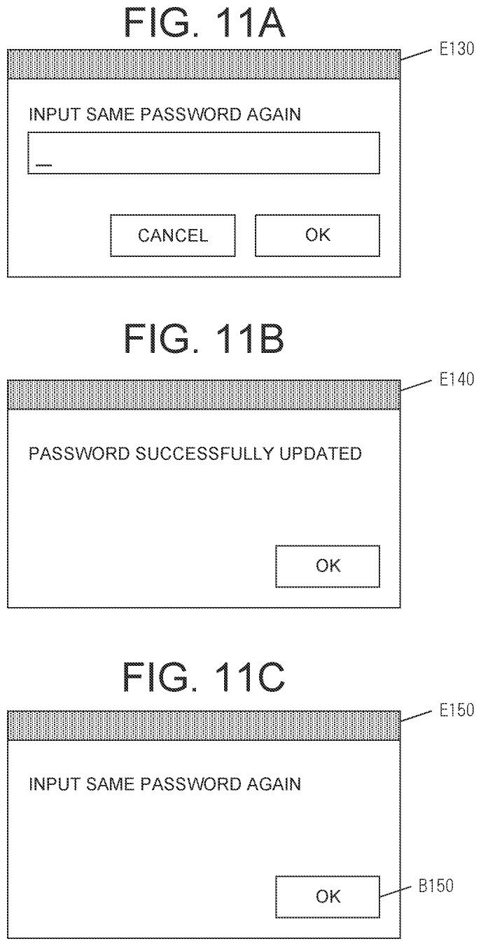

The screens illustrated in FIGS. 10A to 11C are diagrams illustrating screens to be displayed when import processing is performed. Note that, the administrator may perform an import operation at a time of installing the multifunction device 10, or according to needs (e.g., when maintenance of the multifunction device 10 is completed) during an operation of the multifunction device 10.

FIG. 10A illustrates a screen E100 to be displayed in a case where an administrator password does not conform to the security rule at a time of importing import data, and when import processing is terminated in error. In a case where import processing is terminated in error, the administrator changes import data into a content that conforms to the security rule by using another multifunction device 10 or an information processing apparatus, and then, performs an import operation again.

FIG. 10B illustrates a screen E110 (selection screen) to be displayed in a case where the administrator password does not conform to the security rule, and in a case where selection is made between password change and import cancellation. The screen E110 is displayed in step S130 in FIG. 7. The screen E110 includes a password reset button B110 for changing (updating or resetting) a password, and an import cancel button B112 for canceling import processing. In a case where the import cancel button B112 is selected, import processing is canceled and terminated.

On the other hand, in a case where the password reset button B110 is selected, a screen E120 illustrated in FIG. 10C is displayed. The screen E120 is a password change screen for allowing the administrator to input a new password. The screen E120 is displayed in step S134 in FIG. 7. The screen E120 may display a message M120 indicating a security rule that is required to be conformed.

In a case where it is necessary to input a password twice, a screen E130 illustrated in FIG. 11A is displayed. The screen E130 is a screen for allowing the administrator to input a new password again.

In a case where the password input by the administrator conforms to the security rule, a screen E140 illustrated in FIG. 11B is displayed. The screen E140 is a screen for informing the administrator that the password has been successfully changed (updated). On the other hand, in a case where it is necessary to input the password twice, and the password that has been input for the first time and the password that has been input for the second time are different, a screen E150 illustrated in FIG. 11C is displayed. The screen E150 is a screen for informing that the password to be input for the first time and the password to be input for the second time are required to be the same password. The screen E150 includes a button B150 indicating that the content of the displayed message has been confirmed. In a case where the button B150 is selected, the screen E120 illustrated in FIG. 10C is displayed, and inputting a password for the first time is performed again.

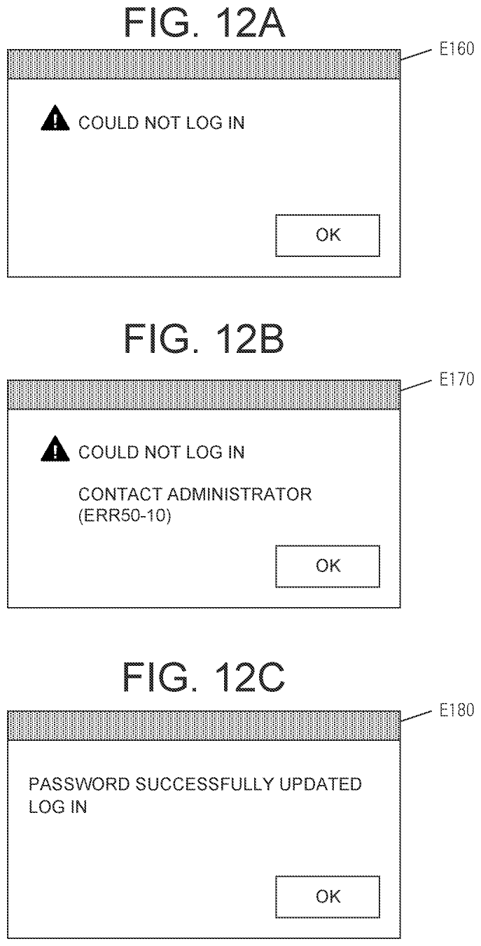

Further, screens illustrated in FIGS. 12A to 12C are diagrams illustrating screens to be displayed when login processing is performed. FIG. 12A illustrates a screen E160 to be displayed in a case where the error condition is an identification authentication error (identification authentication error time). The screen E160 is displayed in a case where authentication has failed, or in a case where the password does not conform to the security rule, and in a case where a notification that the password does not conform to the security rule is disabled.

FIG. 12B illustrates a screen E170 to be displayed in a case where the error condition is a security rule error. In this case, since the user cannot change the password, the user is required to contact the administrator.

On the other hand, in a case where the password input by the user at a login time does not conform to the security rule, but the user could be authenticated by the password, the user is prompted to change the password. At this occasion, a screen similar to the screen E120 illustrated in FIG. 10C or the screen E130 illustrated in FIG. 11A is displayed, and the user is prompted to input the password.

FIG. 12C illustrates a screen E180 to be displayed in a case where the password has been successfully changed. The user can know that the password has been changed (updated) by checking the screen E180. On the other hand, in a case where the password is required to be input twice, and the password that has been input for the first time and the password that has been input for the second time are different, a screen similar to the screen E150 illustrated in FIG. 11C is displayed.

Note that, the above description has been made based on a premise that import processing is performed, or password change is performed according to whether a password included in a setting value conforms to a security rule related to the password. However, it is also possible to set a security rule related to information other than a password, determine whether the information other than the password conforms to the security rule according to the security rule, and perform import processing or changing a setting value.

Further, description has been made based on a premise that security rules are stored in the multifunction device 10. However, in a case where a plurality of multifunction devices 10 are connected to a network and the like, and the plurality of multifunction devices 10 are used in a user environment, security rules may be set and operated for each of the multifunction devices 10, or may be operated in a sharing manner among the plurality of multifunction devices 10. In a case where security rules are shared among the plurality of multifunction devices 10, each of the plurality of multifunction devices 10 and an external server that manages the security rules are made communicable, and the multifunction devices 10 acquire the security rules from the external server by cooperating with the external server. Note that, security rule settings for one multifunction device 10 may be adopted as security rule settings for another multifunction device 10 from among the multifunction devices 10 without using an external server. In a case where security rules are adopted from among the multifunction devices 10, for example, settings for the strongest security rule are adopted in each multifunction device 10. Note that, security rules for a preferential multifunction device 10 (e.g., a parent or master multifunction device 10) may be adopted for each multifunction device 10 (e.g., a child or slave multifunction device 10) with a parent-child or hierarchical relationship among the multifunction devices 10.

Further, the multifunction device 10 may determine whether a setting value conforms to the security rule only for setting values of the administrator, and may not have to determine whether a setting value conforms to the security rule for setting values of a general user. In addition, the multifunction device 10 may exclusively use information and an authentication method (authentication mode) to which security rules are applied. In other words, in a case where an authentication method that does not require a password is available, the multifunction device 10 may use the method that does not require a password, as an authentication method for a general user, and may not have to determine whether the user setting value conforms to the security rule related to a password. Note that, examples of the authentication method that does not require a password include IC card authentication, user number authentication, fixed user login, quick authentication (quick login), and the like. Note that, since some authentication methods allow password settings, in a case where an authentication method that allows password settings is used, determination may also be made as to whether a setting value of a general user conforms to the security rule related to a password.

Although the above description has been made regarding processing to be performed at a time of import processing of import data, similar processing may be performed also in a case where a security level of the multifunction device 10 is raised. For example, the multifunction device 10 may be able to change a setting value of the administrator that does not conform to the security rule, in a case where the security level is raised due to a change of the security rule of the multifunction device 10 itself, as a result of a change in system settings by the administrator. The multifunction device 10 also changes the user setting value in such a way as to conform to the security rule after change at a login time of a general user. For example, the password length may not be allowed to be equal to or less than a certain numerical value. This forcibly allows the security rule to be in an enabled state depending on a security level, set the multifunction device 10 to be in a more secured state, and operate the multifunction device 10 with a stronger setting value than a setting value in a case of a normal security level. In this case, although changing the setting value is required, the multifunction device 10 is allowed to change the setting value at a time of changing the security rule and at a login time.

In this way, the multifunction device according to the present embodiment basically does not check conformity to security rules regarding import of setting values such as identification authentication information. Specifically, the multifunction device determines whether a setting value conforms to a security rule, in a case where the setting value to be imported is a setting value of the administrator, and does not determine whether a setting value conforms to a security rule, in a case where the setting value is a setting value of a general user other than the administrator. Herein, for example, when an authentication function is used for the purpose of restricting an access to the multifunction device in order to improve security of the multifunction device, security rules may be strengthened regarding a password for further security enhancement. However, even in such a case, the multifunction device according to the present embodiment imports setting values of a general user other than the administrator without checking the security rules at a time of import. Therefore, the multifunction device can avoid a situation in which an enormous amount of time is required to deal with processing at an error time of import, and shorten the import time of import data.

On the other hand, the multifunction device according to the present embodiment checks whether a setting value conforms to a security rule, as long as the setting value is a setting value of the administrator at an import time of the setting value. At this occasion, the multifunction device performs import processing, in a case where the setting value of the administrator conforms to the security rule, and when the setting value of the administrator does not conform to the security rule, the multifunction device changes the setting value or suspends import processing. In a case where an operation of changing (resetting) a setting value is performed, the multifunction device imports the setting value in which reset information is adopted (information is updated to information after change), only when the setting value conforms to the security rule. This allows the multifunction device according to the present embodiment to import at least a setting value of the administrator in a state that the setting value surely conforms to the security rule, and to avoid a state in which none of the administrators can log in.

In addition, conventionally, a user setting value (user data) that does not conform to the security rule may not be imported, and the user may not be able to use the multifunction device. In this case, the user who cannot use the multifunction device is required to newly perform user registration. However, the user may be subject to security constraints such as usage restriction in which user registration using the same login name as the login name that the user has been using so far is restricted. In such a case, the user is required to perform registration under a different account using a different user name, and an operation under the different account is required, which may increase a time (downtime) until the user can start using. However, the multifunction device according to the present embodiment imports a setting value of a general user, without determining whether import data conform to the security rule, when importing the setting value of the general user. This allows the multifunction device according to the present embodiment to shorten the time (downtime) when the user cannot use the multifunction device, without performing registration restriction of the same account.

In this way, the multifunction device according to the present embodiment can provide a mechanism that avoids a state in which none of the administrators can log in to the multifunction device, and reduces management labor regarding import of import data, while taking security rules into consideration.

### 2. Second Embodiment

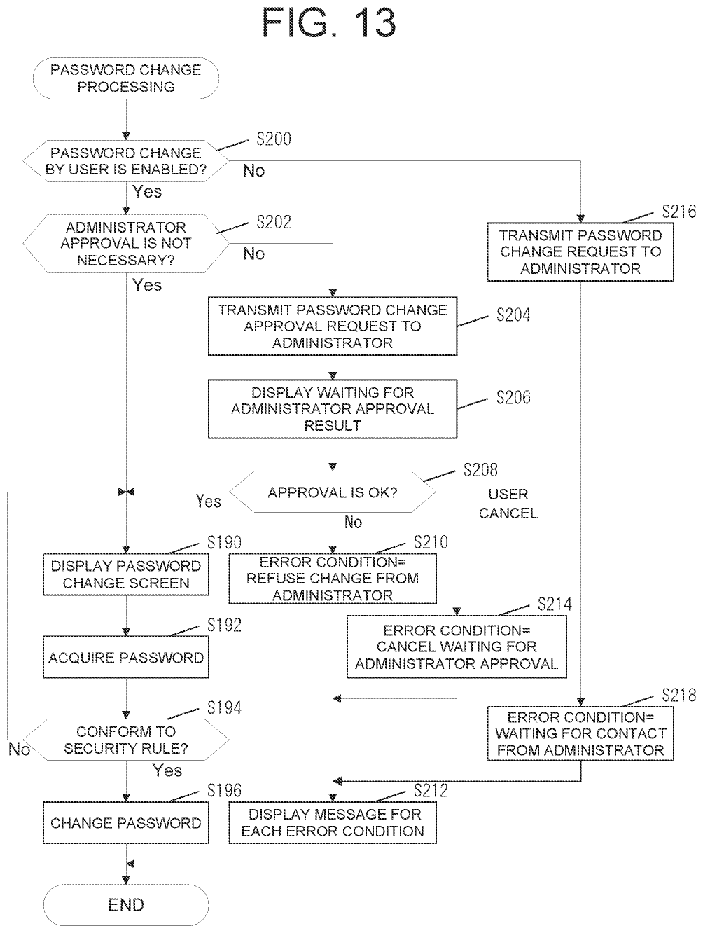

Next, a second embodiment is described. The second embodiment is an embodiment in which, in addition to the processing described in the first embodiment, only an administrator is allowed to reset a setting value, or a user is allowed to reset a setting value only with the permission of the administrator. The present embodiment is an embodiment in which FIG. 9 in the first embodiment is replaced by FIG. 13. Note that, the same processing is indicated with the same reference sign, and description thereof is omitted.

### 2.1 Functional Configuration

In the present embodiment, the following settings are stored in a system setting information table 166, as settings for improving convenience.

Refusal of Password Change

This setting is a setting indicating whether password change by the user is made possible.

Presence or Absence of Requirement of Administrator Approval for Password Change

This setting is a setting indicating whether the administrator is required to approve password change, when password change is requested by the user in a case where password change by the user is possible. In a case where approval is required, the administrator can detect occurrence of a login failure event at a time of occurrence, or confirm the event after occurrence of the event. On the other hand, in a case where approval is not required, the user can immediately change the password, thus improving convenience.

### 2.2 Flow of Processing

Password change processing according to the present embodiment is described with reference to FIG. 13. First, a controller 100 determines whether password change by the user is enabled based on a system setting value stored in the system setting information table 166 (step S200).

In a case where password change by the user is enabled, the controller 100 determines whether administrator approval is not required (step S200; Yes→step S202).

In a case where administrator approval is not required (step S202; Yes), password change is performed by performing the pieces of processing from step S190 through step S196.

On the other hand, in a case where it is determined that administrator approval is required in step S202, the controller 100 transmits a request for approval for password change (password change approval request) to the administrator (step S202; No→step S204). Note that, the administrator who can approve password change may be a device administrator, an administrator (default administrator) set as an administrator who approves password change, or an administrator user. Note that, in a case where approval for password change is performed by an administrator user, the number of administrator users who can approve password change may be limited.

After transmitting a password change approval request, the controller 100 displays, on a displayer 144, a screen indicating that the controller 100 is in a state of waiting for an approval result by the administrator (step S206).

Subsequently, the controller 100 determines whether password change has been approved by the administrator (step S208). For example, the controller 100 determines that password change has been approved by the administrator, in a case where information indicating that password change is approved is acquired from the administrator to whom a password change approval request is to be transmitted, or an operation indicating that password change is approved is performed. In a case where password change is approved by the administrator, the controller 100 performs the processing in step S190 (step S208; Yes→step S190).

On the other hand, in a case where password change is not approved by the administrator, the controller 100 sets the error condition to “refuse change from an administrator”, and displays a message for each error condition (step S208; No→step S210→step S212). Note that, the processing in step S212 is the same as that in step S164 in FIG. 8.

Further, when password change is canceled by the user in a case where password change approval by the administrator is acquired, the controller 100 sets the error condition to “cancel waiting for administrator approval” (step S208; user cancel→step S214). In this case, the controller 100 displays a message according to the error condition “cancel waiting for administrator approval” by performing the processing in step S212. Note that, the controller 100 may notify the administrator to whom a password change approval request is to be transmitted of that password change has been canceled by the user.

Note that, in a case where password change by the user is disabled in step S200, the controller 100 transmits a password change request to the administrator (step S200; No→step S216). Note that, the administrator to whom a password change request is to be transmitted may be a device administrator, a default administrator, or an administrator user, as in the case of step S204. The controller 100 also sets the error condition to “wait for a contact from the administrator” (step S218). In this case, the controller 100 displays a message according to the error condition “wait for a contact from the administrator” by performing the processing in step S212.

Note that, the administrator who has received the password change request performs change (re-registration) of the password. To allow the administrator to perform password change, for example, in a case where the controller 100 acquires information on a login name and a password from the administrator to whom the password change request is to be transmitted in step S216, the controller 100 changes the password stored in identification authentication information including the login name to the password acquired from the administrator. This enables to change the password of the user whose password is to be changed to a password that conforms to a security rule for the password. Note that, in a case where the password acquired from the administrator does not conform to the security rule for the password, the controller 100 may request the password again to the administrator. The administrator may also notify the user who has requested password change, of the password after change. Note that, the controller 100 may notify the user whose password is to be changed, of that the password has been changed at a timing when identification authentication information is changed based on the password acquired from the administrator.

### 2.3 Operation Example

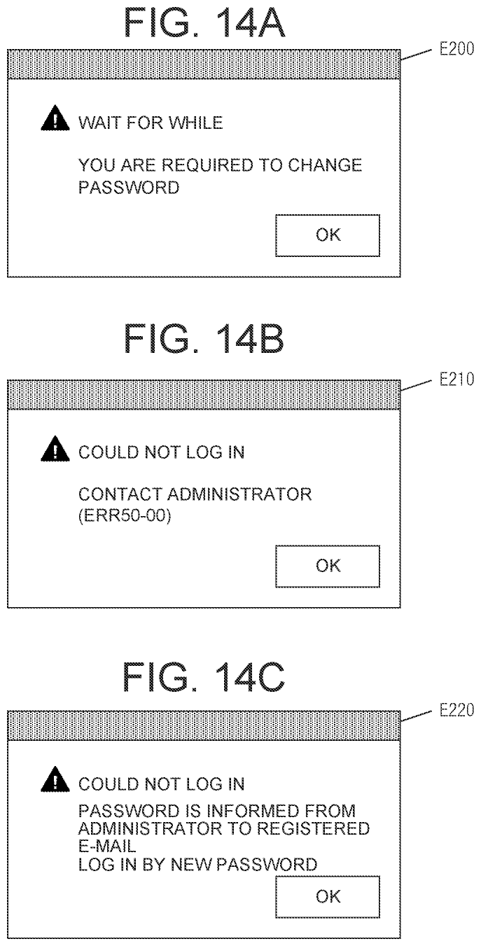

Screens illustrated in FIGS. 14A to 14C are diagrams illustrating screens to be displayed when login processing is performed. FIG. 14A illustrates a screen E200 to be displayed when a result of administrator approval is waited. The screen E200 is displayed in step S206 in FIG. 13.

FIG. 14B illustrates a screen E210 to be displayed when user cancellation is performed in a state of waiting for administrator approval. The screen E210 is displayed by performing step S212 after step S214 in FIG. 13 has been performed.

FIG. 14C illustrates a screen E220 to be displayed in a case where the controller 100 is waiting for a contact from the administrator. The screen E220 is displayed by performing step S212 after step S218 in FIG. 13 has been performed.

In this way, in a case where a user setting value does not conform to the security rule, the multifunction device according to the present embodiment allows the administrator to edit (re-register) into information that conforms to the security rule according to system settings of the multifunction device. The multifunction device according to the present embodiment can also require approval by the administrator, in a case where user information is edited (re-registered) according to system settings of the multifunction device. In this way, the multifunction device according to the present embodiment allows the administrator to change a setting value, in a case where the user setting value does not conform to the security rule, thereby avoiding a situation in which the administrator cannot recognize password change by a general user.

### 3. Third Embodiment

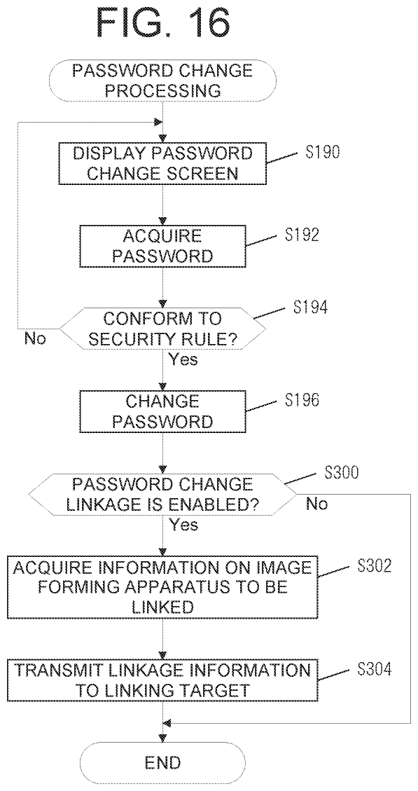

Next, a third embodiment is described. The third embodiment is an embodiment in which, in addition to the processing described in the first embodiment, in a case where a password is changed in one multifunction device, it is possible to change the password of identification authentication information (account information) of the same user who is registered in association with another multifunction device. The present embodiment is an embodiment in which FIG. 9 of the first embodiment is replaced by FIG. 16. Note that, the same processing is indicated with the same reference sign, and description thereof is omitted.

### 3.1 Overall Configuration

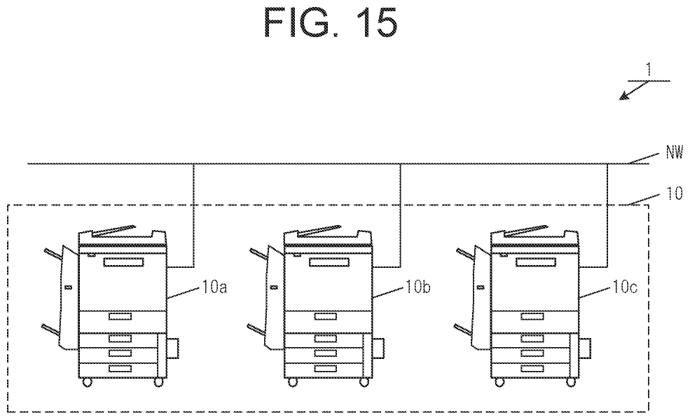

FIG. 15 is a diagram illustrating an overall configuration of a system 1 according to the present embodiment. In the present embodiment, the system 1 is configured in such a way that a plurality of multifunction devices 10 (in the example in FIG. 15, multifunction devices 10a, 10b, and 10c) are connected via a network NW. The network NW is a network that connects each device. For example, the network NW is achieved, for example, by a local area network (LAN) or a wide area network (WAN), but a network other than a LAN or a WAN may be used, as long as each device can exchange information with each other.

### 3.2 Functional Configuration

In the present embodiment, the following settings are stored in a system setting information table 166, as settings for improving convenience.

Setting Information is Shared Among the Multifunction Devices 10 (Information Linkage)

The settings are settings indicating whether setting values are shared by linkage of the plurality of multifunction devices 10. For example, in a case where sharing settings on setting information among the multifunction devices 10 are enabled, when a password is changed in one of the multifunction device 10, the password of identification authentication information (account information) of the same user who is registered in another multifunction device 10 is also changed (updated or reset).

### 3.3 Flow of Processing

3.3.1 Administrator Password Change Processing

Administrator password change processing according to the present embodiment is described with reference to FIG. 16. In the present embodiment, a controller 100 determines whether password change linkage is enabled after the password is changed in step S196 (step S300).

In a case where password change linkage is enabled, the controller 100 acquires information on the multifunction device 10 to be linked (step S300; Yes→step S302). The information on the multifunction device 10 to be linked is, for example, an address of the multifunction device 10. For example, information on the multifunction device 10 to be linked is stored in advance in a storage 160 or in the system setting information table 166, and the controller 100 acquires information on the multifunction device 10 to be linked from the storage 160. Note that, a management server that manages the multifunction device 10 may be provided in advance, and the controller 100 may acquire information on the multifunction device 10 to be linked from the management server. Also, the controller 100 may perform broadcast communication with respect to the network NW, and acquire information on the multifunction device 10 to be linked in response to a reply from the multifunction device 10.

Subsequently, the controller 100 transmits a notification (linkage information) for linking a setting value with respect to the multifunction device 10 to be linked via a communicator 190 (step S304). The linkage information includes, for example, a password after change (information on a setting value after change), and information (e.g., a login name) for determining a user whose password is to be changed (a user for whom a password change operation has been performed). Note that, in a case where the controller 100 determines that password change linkage is disabled in step S300, the pieces of processing in steps S302 and S304 are omitted (step S300; No).

3.3.2 Password-Associated Change Processing

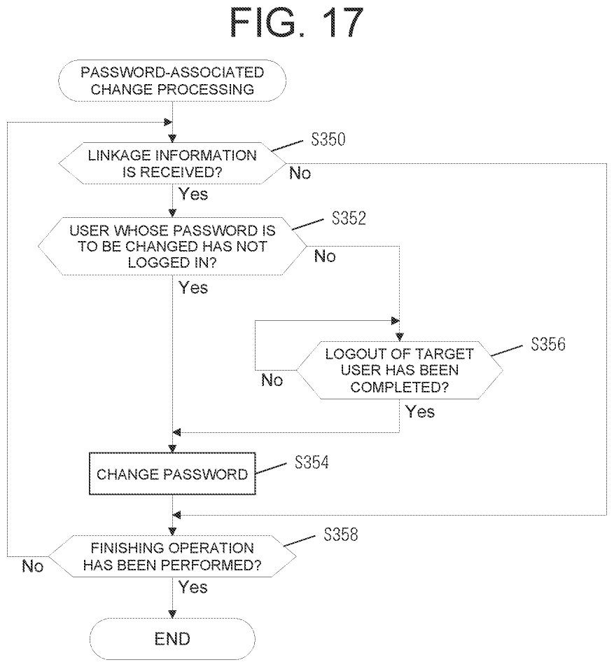

Next, password-associated change processing, which is processing to be performed by the multifunction device 10 to change a password, based on linkage information, in a case where the multifunction device 10 receives the linkage information from another multifunction device 10, is described with reference to FIG. 17. The password-associated change processing is performed by causing the controller 100 to read a program stored in the storage 160. Note that, the controller 100 performs password-associated change processing in parallel with processing of causing the controller 100 to exhibit a function included in the multifunction device 10, such as login processing.

First, the controller 100 determines whether the controller 100 has received linkage information from another multifunction device 10 via the communicator 190 (step S350). In a case where the controller 100 has received linkage information, the controller 100 determines whether the user whose password is to be changed has not logged in (not in a login state) to his/her device, based on the linkage information (step S352).

In a case where the user whose password is to be changed has not logged in, the controller 100 changes the setting value, based on the linkage information received in step S350 (step S352; Yes→step S354). For example, in a case where linkage information includes a password after change (information on a setting value after change), and information for determining the user, the controller 100 changes the password stored in identification authentication information of the user to be determined based on the information for determining the user to the password after change.

On the other hand, in a case where the user whose password is to be changed is logging in to his/her device, the controller 100 determines whether logout of the user has been completed (step S352; No→step S356). In a case where logout of the user whose password is to be changed has not been completed, the controller 100 repeats the processing in step S356 (step S356; No). The controller 100 waits for logout of the user whose password is to be changed, and changes the setting value after logout of the user is completed (step S356; Yes→step S354).

Note that, in a case where the controller 100 determines in step S350 that the controller 100 has not received linkage information, the pieces of processing from step S352 through step S356 are omitted (step S350; No).

Subsequently, the controller 100 determines whether a finishing operation has been performed (step S358). The finishing operation is, for example, an operation of selecting a button to turn off the power of the multifunction device 10. In a case where a finishing operation is performed, the controller 100 terminates the processing illustrated in FIG. 17 (step S358; Yes). On the other hand, in a case where a finishing operation has not been performed, the controller 100 returns to step S350 (step S358; No).

Note that, the controller 100 may have a condition for determining whether to change a password included in identification authentication information stored in an identification authentication information storage area 162, and may determine in step S354 whether to change the password according to the condition. For example, a setting item “presence or absence of change when receiving linkage information” may be provided in the system setting information table 166. In this case, when the controller 100 receives linkage information, the controller 100 determines whether to change a setting value such as a password according to a system setting value of the setting item, and when the change at a time of receiving linkage information is enabled, the setting value is changed based on the linkage information. On the other hand, when the change at a time of receiving linkage information is disabled, the controller 100 does not change the setting value, even when the controller 100 receives the linkage information. In addition, a parent-child relationship or a hierarchical relationship may be set in each multifunction device 10, and in a case where the controller 100 receives linkage information from a parent or master multifunction device 10, the controller 100 may change the password, and in a case where the controller 100 receives linkage information from a child or slave multifunction device 10, the controller 100 may not change the password.

In this way, as described in the present embodiment, in a case where a plurality of multifunction devices are used, when information such as a password is changed according to a security rule in one of the plurality of multifunction devices, information such as a password can be changed also in another multifunction device. This allows the system according to the present embodiment to improve user convenience in a case where a plurality of multifunction devices are used.

### 4. Modification Examples

The present disclosure is not limited to the above-described embodiments, and various modifications are available. Specifically, embodiments to be acquired by appropriately combining modified technical means within a range that does not depart from the gist of the present disclosure are also included in the technical scope of the present disclosure. Further, although the above description describes a case in which the information processing apparatus according to the present disclosure is applied to a multifunction device, the present disclosure may be applied to an information processing apparatus other than a multifunction device.

Furthermore, although the above-described embodiments include some parts described separately for convenience of explanation, it is needless to say that it is possible to combine and implement the embodiments within a technically possible range. For example, the second embodiment and the third embodiment may be combined. In this case, the multifunction device can be made to require approval by an administrator in changing a password, and when the password is changed, it becomes possible to change the password for another multifunction device.

In addition, a program operating in each device in the embodiments is a program (a program causing a computer to function) that controls a CPU or the like in such a way as to achieve functions of the above-described embodiments. Further, information to be handled by these devices is temporarily stored in a temporary storage device (e.g., a RAM) at a time of processing, and thereafter, is stored in a storage device such as various read only memories (ROMs), and HDDs, and is read and corrected/written by the CPU as necessary.

Herein, a recording medium for storing the program may be any of a semiconductor medium (e.g., a ROM, a non-volatile memory card, and the like), an optical recording medium/magneto-optical recording medium (e.g., a digital versatile disc (DVD), a magneto optical disc (MO), a mini disc (MD), a compact disc (CD), a Blu-ray (registered trademark) disc (BD), and the like), a magnetic recording medium (e.g., a magnetic tape, a flexible disk, and the like), and the like. In addition, not only functions of the above-described embodiments are achieved by executing a loaded program, but also functions of the present disclosure may be achieved by processing the program jointly with an operating system, other application program, or the like, based on an instruction of the program.

Further, in a case of distributing the program in the market, the program can be stored in a portable recording medium and distributed, or can be transferred to a server computer connected via a network such as the Internet. In this case, it is needless to say that a storage device of the server computer is also included in the present disclosure.

What is claimed is:

1. An information processing apparatus comprising:
an authenticator that authenticates a user according to a setting value;
an acquirer that acquires the setting value;
a determiner that determines whether a setting value of an administrator, included in the setting value acquired by the acquirer, satisfies a setting value rule; and
a processor that imports the setting value of a user other than the administrator as it is, when importing the setting value acquired by the acquirer, and performs processing of suspending importing, in a case where the determiner determines that the setting value of the administrator does not satisfy the rule.

2. The information processing apparatus according to claim 1, wherein
the processor acquires a new setting value with respect to the setting value of the administrator, when importing is suspended, and performs importing after changing the setting value to the new setting value, in a case where the new setting value satisfies the rule.

3. The information processing apparatus according to claim 1, wherein
in a case where a setting value associated with the user does not satisfy the rule, the processor displays a message, to the user, indicating that authentication has failed at a time of authenticating the user by the authenticator.

4. The information processing apparatus according to claim 1, wherein
in a case where a setting value associated with a user authenticated by the authenticator does not satisfy the rule, the processor allows the user to change the setting value.

5. The information processing apparatus claim 4, wherein
the processor allows the user to change the setting value, when changing the setting value is permitted by the administrator.

6. The information processing apparatus according to claim 1, wherein
in a case where a setting value associated with a user authenticated by the authenticator does not satisfy the rule, the processor changes the setting value of the user to a new setting value acquired from the administrator, when the new setting value is acquired from the administrator.

7. The information processing apparatus according to claim 1, further comprising:
a transmitter that transmits information on a setting value after change, in a case where a setting value is changed; and
a receiver that receives information on the setting value after the change, wherein
in a case where information on the setting value after the change is received by the receiver, the processor changes a setting value before change, based on information on the setting value after the change.

8. A control method comprising:
acquiring a setting value;
determining whether a setting value of an administrator, included in the setting value, satisfies a setting value rule; and
importing the setting value of a user other than the administrator as it is, when importing the setting value, and performing processing of suspending importing, in a case where the setting value of the administrator does not satisfy the rule.
